(19) United States
(12) Patent Application Publication
(10) Pub. No.: US 2026/0066476 A1
(43) Pub. Date: Mar. 5, 2026

(54) BATTERY ARRAY BUSBAR FRAME DESIGNS

(71) Applicant: FORD GLOBAL TECHNOLOGIES, LLC, Dearborn, MI (US)

(72) Inventors: Jie Deng, Novi, MI (US); Brian Utley, Canton, MI (US); Sangyeon Kim, Northville, MI (US)

(21) Appl. No.: 18/816,182

(22) Filed: Aug. 27, 2024

(51) Int. Cl. H01M 50/503; B60L 50/64; H01M 10/613; H01M 10/6567; H01M 50/211; H01M 50/271; H01M 50/507

(52) U.S. Cl. CPC H01M 50/503; B60L 50/64; H01M 10/613; H01M 10/6567; H01M 50/211; H01M 50/271; H01M 50/507; H01M 2220/20

(57) ABSTRACT

Battery array busbar frame designs are disclosed for use within traction battery packs. An exemplary battery array may include a busbar frame that includes features that facilitate the use of mechanical fastenerless connections inside the battery array. These features may include legs that can be mounted to a top cover and/or bottom cover of an array housing via an adhesive, and holders that provide an interface for connecting cell spacers to the busbar frame in order to mitigate busbar frame and/or cell spacer motion and increase the structural integrity of the battery array. Gaps between adjacent legs of the busbar frame may further establish coolant flow passages for directing a coolant around battery cells in order to thermally manage the battery array.

### TECHNICAL FIELD

This disclosure relates generally to electrified vehicle traction battery packs, and more particularly to busbar frame designs that facilitate mechanical fastenerless connections to other battery array components.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, an array housing, and a cell stack housed within the array housing and including a plurality of battery cells arranged between a first busbar frame and a second busbar frame. Each of the first busbar frame and the second busbar frame includes a first leg configured to interface with the array housing.

In a further non-limiting embodiment of the foregoing battery array, the first leg interfaces with a top cover of the array housing.

In a further non-limiting embodiment of either of the foregoing battery arrays, an adhesive is disposed between a flat surface of the first leg and the top cover.

In a further non-limiting embodiment of any of the foregoing battery arrays, the first leg interfaces with a bottom cover of the array housing.

In a further non-limiting embodiment of any of the foregoing battery arrays, an adhesive is disposed between a flat surface of the first leg and the bottom cover.

In a further non-limiting embodiment of any of the foregoing battery arrays, the first leg interfaces with a top cover of the array housing, and a second leg of each of the first busbar frame and the second busbar frame interfaces with a bottom cover of the array housing.

In a further non-limiting embodiment of any of the foregoing battery arrays, a first adhesive is disposed between a first flat surface of the first leg and the top cover, and a second adhesive is disposed between a second flat surface of the second leg and the bottom cover.

In a further non-limiting embodiment of any of the foregoing battery arrays, each of the first busbar frame and the second busbar frame includes a second leg configured to interface with the array housing. A gap extends between the first leg and the second leg.

In a further non-limiting embodiment of any of the foregoing battery arrays, the gap establishes a coolant flow passage inside the array housing.

In a further non-limiting embodiment of any of the foregoing battery arrays, each of the first busbar frame and the second busbar frame includes a holder configured to interface with a cell spacer of the cell stack.

In a further non-limiting embodiment of any of the foregoing battery arrays, the holder is U-shaped, and an adhesive is disposed between the holder and the cell spacer.

In a further non-limiting embodiment of any of the foregoing battery arrays, the holder includes a pair of flexible hook structures that are configured to engage a slot formed in the cell spacer.

A battery array for a traction battery pack according to another exemplary aspect of the present disclosure includes, among other things, an array housing, and a cell stack housed within the array housing and including a plurality of battery cells and a plurality of cell spacers arranged to extend laterally between a first busbar frame and a second busbar frame. Each of the first busbar frame and the second busbar frame includes a first leg configured to interface with the array housing, and a first holder configured to interface with a first cell spacer of the plurality of cell spacers.

In a further non-limiting embodiment of the foregoing battery array, the first holder is U-shaped, and an adhesive is disposed between the first holder and the first cell spacer.

In a further non-limiting embodiment of either of the foregoing battery arrays, the first holder includes a pair of flexible hook structures that are configured to engage a slot formed in the first cell spacer.

In a further non-limiting embodiment of any of the foregoing battery arrays, the first leg interfaces with a top cover of the array housing, and an adhesive is disposed between a flat surface of the first leg and the top cover.

In a further non-limiting embodiment of any of the foregoing battery arrays, the first leg interfaces with a bottom cover of the array housing, and an adhesive is disposed between a flat surface of the first leg and the bottom cover.

In a further non-limiting embodiment of any of the foregoing battery arrays, the first leg interfaces with a top cover of the array housing, and a second leg of each of the first busbar frame and the second busbar frame interfaces with a bottom cover of the array housing.

In a further non-limiting embodiment of any of the foregoing battery arrays, each of the first busbar frame and the second busbar frame includes a second leg configured to interface with the array housing. A gap extends between the first leg and the second leg.

In a further non-limiting embodiment of any of the foregoing battery arrays, the gap establishes a coolant flow passage inside the array housing.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of an exemplary battery array of a traction battery pack.

FIG. 3 is an exploded view of the battery array of FIG. 2.

FIG. 4 is a blown-up view of a select portion of a cell stack of the battery array shown in FIG. 3.

FIG. 5 illustrates an exemplary busbar frame of a battery array.

FIG. 6 is a blown-up view of a select portion of the busbar frame shown in FIG. 5.

FIG. 7 illustrates another exemplary busbar frame.

FIG. 8 illustrates yet another exemplary busbar frame.

FIG. 9 schematically illustrates a busbar frame mounted between top and bottom array housing covers for establishing coolant flow passages.

FIG. 10 is a cross-sectional view through section 10-10 of FIG. 9.

FIG. 11 illustrates an interface between a busbar frame and a cell spacer.

FIG. 12 illustrates select portions of another exemplary busbar frame.

FIG. 13 illustrates an interface between the busbar frame of FIG. 12 and a cell spacer.

FIG. 14 is a blown-up view of a select portion of the interface shown in FIG. 13.

### DETAILED DESCRIPTION

This disclosure details battery array busbar frame designs for use within traction battery packs. An exemplary battery array may include a busbar frame that includes features that facilitate the use of mechanical fastenerless connections inside the battery array. These features may include legs that can be mounted to a top cover and/or bottom cover of an array housing via an adhesive, and holders that provide an interface for connecting cell spacers to the busbar frame in order to mitigate busbar frame and/or cell spacer motion and increase the structural integrity of the battery array. Gaps between adjacent legs of the busbar frame may further establish coolant flow passages for directing a coolant around battery cells in order to thermally manage the battery array. These and other features are discussed in greater detail in the following paragraphs of this detailed description.

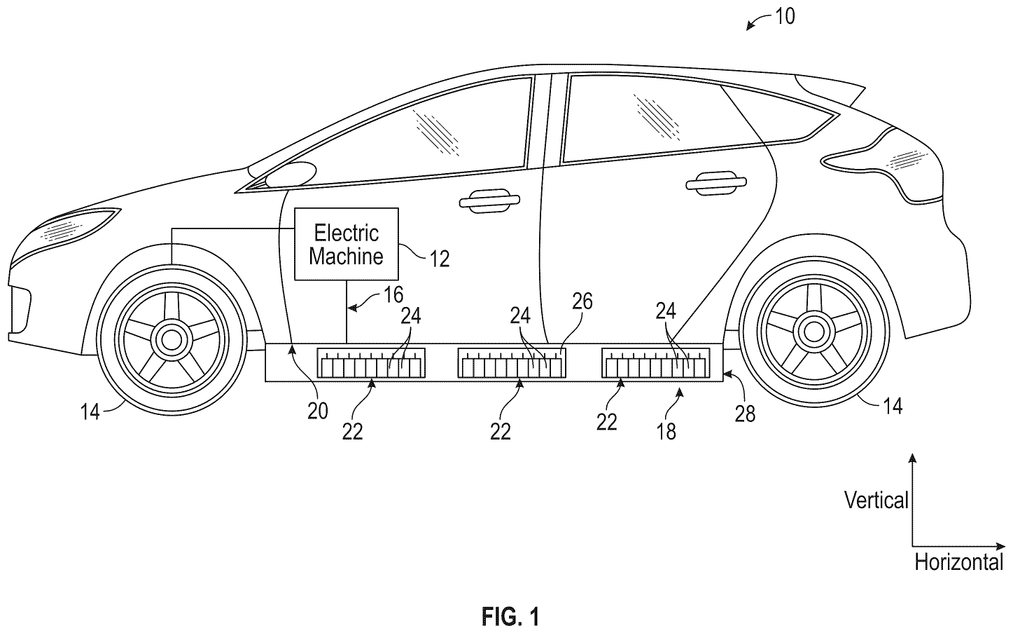

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

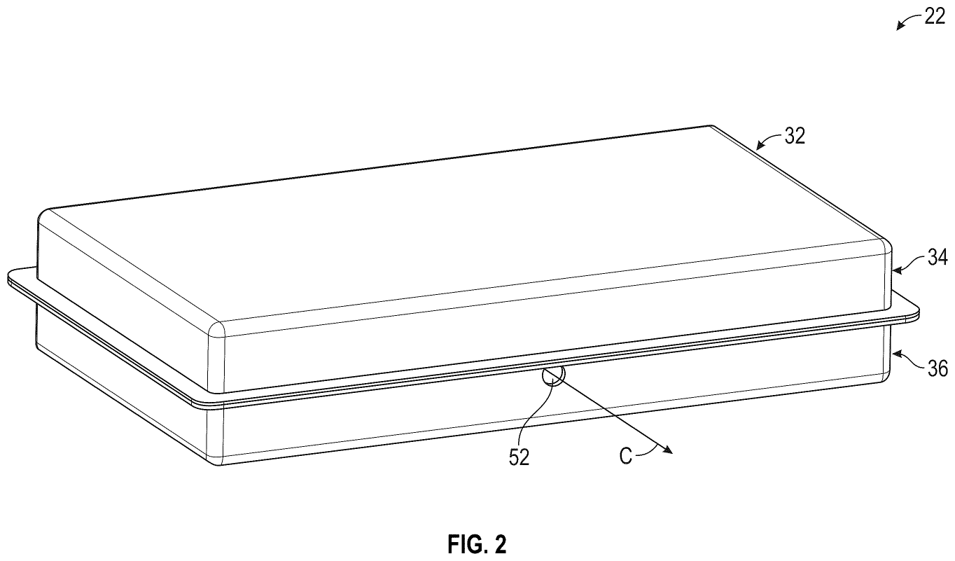

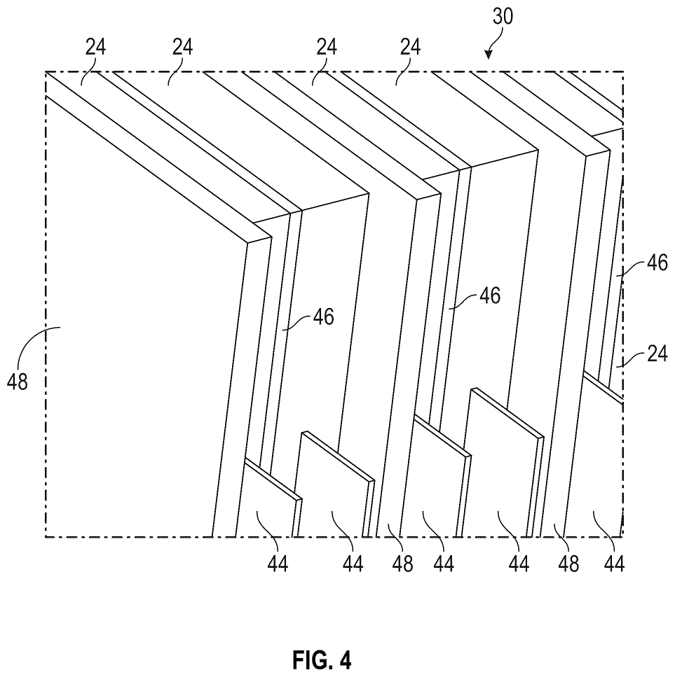

FIGS. 2-4 illustrate features associated with a battery array 22 for a traction battery pack. For example, the traction battery pack 18 of the electrified vehicle 10 of FIG. 1 could include one or more battery arrays having a design substantially similar to that of the battery array 22 shown in FIGS. 2-4.

The battery array 22 may include one or more cell stacks 30 housed within an array housing 32. The array housing 32 may include a top cover 34 and a bottom cover 36. The top cover 34 may be positioned vertically above the bottom cover 36. Various terms such as “above,” “below,” “top,” and “bottom” are used relative to the arrangement of the components of the traction battery pack 18 in the various drawings and should not otherwise be deemed limiting. These terms are with reference to the general orientation of the traction battery pack 18 when installed on the electrified vehicle 10 of FIG. 1. Vertical, for purposes of this disclosure, is also with reference to ground and how the traction battery pack 18 is oriented when installed on the electrified vehicle 10.

The top cover 34 may be secured (e.g., bolted, welded, adhered, etc.) to the bottom cover 36 to provide a sealed enclosure for housing the cell stack 30. The size, shape, and configuration of the array housing 32 may vary within the scope of this disclosure.

The cell stack 30 may include a plurality of individual battery cells 24 arranged longitudinally between opposing end plates 38 and laterally between opposing busbar frames 40. The battery cells 24 may be arranged together along a cell stack axis A between the opposing end plates 38. The busbar frames 40 may be configured to position and hold a plurality of busbars 42 relative to the battery cells 24. The busbar frames 40 may locate the busbars 42 at a proper position for securing (e.g., welding) the busbars 42 to terminals 44 of the battery cells 24. The busbar frames 40 may additionally function to isolate the busbars 42 from other electrically conductive components of the battery array 22, such as housings of the battery cells 24, for example.

Although a single cell stack 30 having a specific number of battery cells 24 and busbars 42 is illustrated in the figures of this disclosure, the battery array 22 could include any number of cell stacks 30, with each cell stack 30 having any number of individual battery cells 24 and busbars 42.

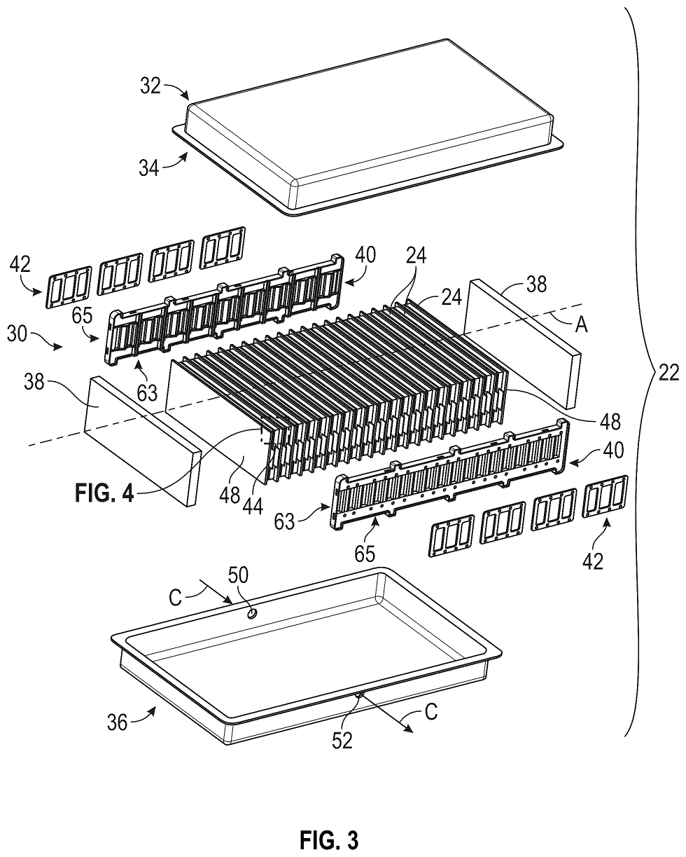

A cell expansion pad 46 (best shown in FIG. 3) may be arranged between some neighboring battery cells 24 within the cell stack 30. The cell expansion pads 46 may include a material(s) (e.g., polyurethane foam, silicone foam, etc.) adapted for accommodating battery cell swelling.

One or more cell spacers 48 may additionally be arranged along the cell stack axis A of the cell stack 30. The cell spacers 48 may include metallic fins, thermal barriers, foam layers, or any combination of these components. The cell spacers 48 may thus in at least some implementations function as thermal barriers for mitigating the cell-to-cell transfer of thermal energy across the cell stack 30.

In an embodiment, groups of four individual battery cells 24 are separated by cell spacers 48 along the cell stack axis A of the cell stack 30. However, other configurations are contemplated within the scope of this disclosure, and it should be apparent those having the benefit of this disclosure that the cell stack 30 could include any number of and any arrangement of battery cells 24, cell expansion pads 46, and cell spacers 48.

Thermal energy levels of the battery cells 24 of the battery array 22 can increase as the electrified vehicle 10 is operated. A thermal management system can be employed for managing the thermal energy levels of the battery cells 24 of the battery array 22. The thermal management system may be configured to route a coolant C through the battery array 22 in order to manage the thermal energy within the battery array 22 by, for example, using the coolant C to take on heat from the battery cells 24 of the cell stack 30.

In an embodiment, the thermal management system is an immersion thermal management system in which portions of the cell stack 30, here at least portions of the battery cells 24, for example, can be immersed in the coolant C. Thermal energy can transfer between the coolant C and the battery cells 24 as the coolant C flows over and/or around the battery cells 24 inside the array housing 32. The coolant C can help manage thermal energy levels of the battery cells 24 as well as other components of the battery array 22, such as the busbars 42, for example.

The thermal management system can deliver the coolant C to the interior area of the battery array 22 through an inlet 50 of the array housing 32. The coolant C can fill one or more open areas inside the battery array 22 such that the battery cells 24 are immersed in, and directly contacted by, the coolant C. The coolant C can take on thermal energy from the battery cells 24 for managing the thermal energy levels. The coolant C may exit the battery array 22 through an outlet 52 of the array housing 32. In an embodiment, both the inlet 50 and the outlet 52 are formed through the bottom cover 36 of the array housing 32. However, other inlet 50 and/or outlet 52 locations are contemplated within the scope of this disclosure.

The coolant C exiting through the outlet 52 can move to a thermal energy exchange device (not shown), such as a heat exchanger, where thermal energy can be transferred from the coolant C to atmosphere. A pump (not shown) can be operated to selectively circulate the coolant C between the battery array 22 and the thermal energy exchange device and then back to the battery array 22 as part of a closed-loop system.

The coolant C circulated in the immersion thermal management system may be a dielectric fluid or another type of non-conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, etc.) may vary depending on the environment the battery array 22 is to be employed within.

In another embodiment, the thermal management system is a conventional cold plate system in which the coolant C, such as glycol, is circulated through a cold plate (not shown) in order to thermally manage heat generated by the battery cells 24. The teachings of this disclosure are therefore not limited to battery arrays having immersion thermal management systems. The battery cells 24 are not immersed in the coolant C in the cold plate type of thermal management system.

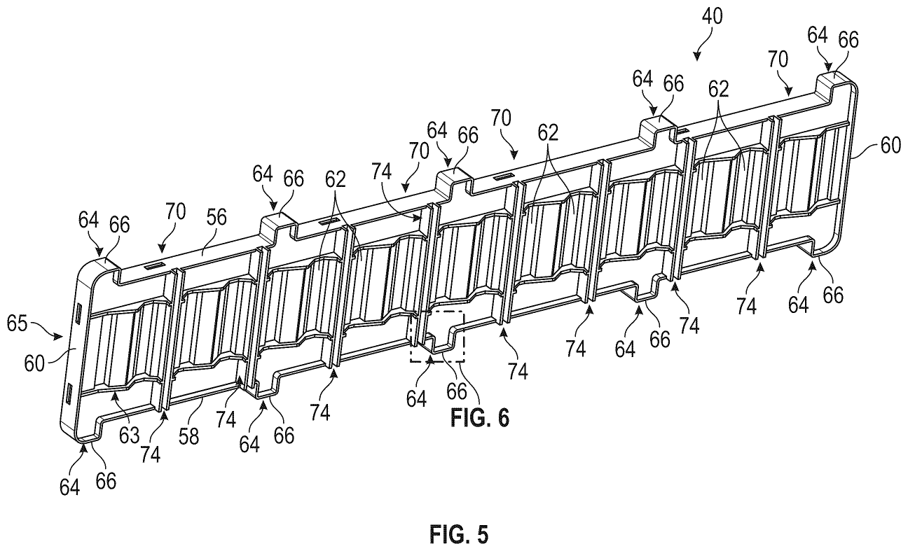

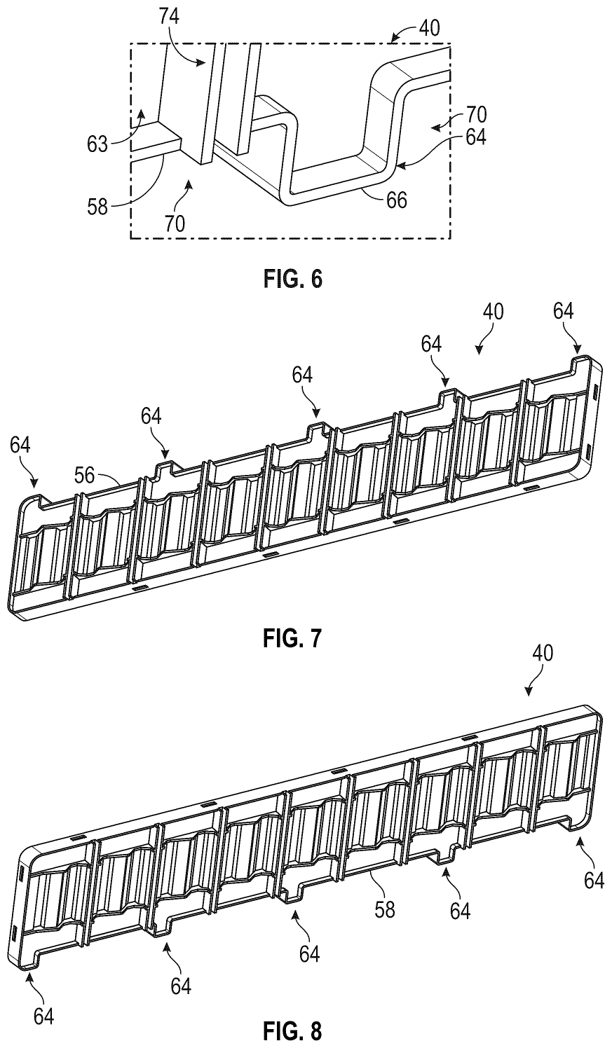

FIGS. 5-6, with continued reference to FIGS. 2-4, illustrate additional details associated with the busbar frames 40 of the cell stack 30. As further described below, in addition to positioning and retaining the busbars 42 relative to the battery cells 24, each busbar frame 40 may include features designed to facilitate mechanical fastenerless (i.e., without the use of screws, bolts, rivets, etc.) connections relative to both the array housing 32 and the cell spacers 48, and each busbar frame 40 may further include features for establishing coolant flow passages for directing the coolant C of the thermal management system over, under, and/or around the battery cells 24 in order to thermally manage the battery array 22.

Each busbar frame 40 may include a top wall 56, a bottom wall 58, opposing end walls 60 that connect between the top wall 56 and the bottom wall 58, a first side face 63, and a second side face 65. In an assembled condition of the battery array 22, the top wall 56 faces toward the top cover 34 of the array housing 32, the bottom wall 58 faces toward the bottom cover 36 of the array housing 32, the first side face 63 of the busbar frame 40 faces toward and interfaces with the battery cells 24 and cell spacers 48 of the cell stack 30, and the second side face 65 faces toward and interfaces with the busbars 42 of the cell stack 30. The busbars 42 may be mounted to the second side face 65 of the busbar frame 40.

A plurality of cell terminal openings 62 may be formed through the busbar frame 40. The busbar frame 40 may therefore exhibit a ladder frame-like design. The cell terminal openings 62 may be elongated slots that open through both the first side face 63 and the second side face 65 for accommodating the terminals 44 of the battery cells 24. In an embodiment, each cell terminal opening 62 may accommodate one terminal 44 from a single battery cell 24 of the cell stack 30. In another embodiment, each cell terminal opening 62 may be sized to receive terminals 44 from multiple adjacent battery cells 24 of the cell stack 30.

One or more legs 64 may protrude outwardly from both the top wall 56 and the bottom wall 58 (see FIG. 5), from only the top wall 56 (see FIG. 7), or from only the bottom wall 58 (see FIG. 8) of the busbar frame 40. The total number, size, shape, and location of the legs 64 may depend on the structural and assembly requirements of the battery array 22, among other factors. This disclosure is therefore not intended to be limited to the specific designs shown in the figures.

Each leg 64 may be configured to establish an interface between the busbar frame 40 and the top cover 34 and/or bottom cover 36 of the array housing 32. Each leg 64 may each include a flat surface 66 for securing the busbar frame 40 directly to the array housing 32.

The legs 64 may be spaced apart from another along the top wall 56 and/or the bottom wall 58 to provide gaps 70 in the busbar frame 40. The distance between adjacent legs 64 (and thus the size of the gaps 70) of the busbar frame 40 may depend on the structural and assembly requirements of the battery array 22, among other factors.

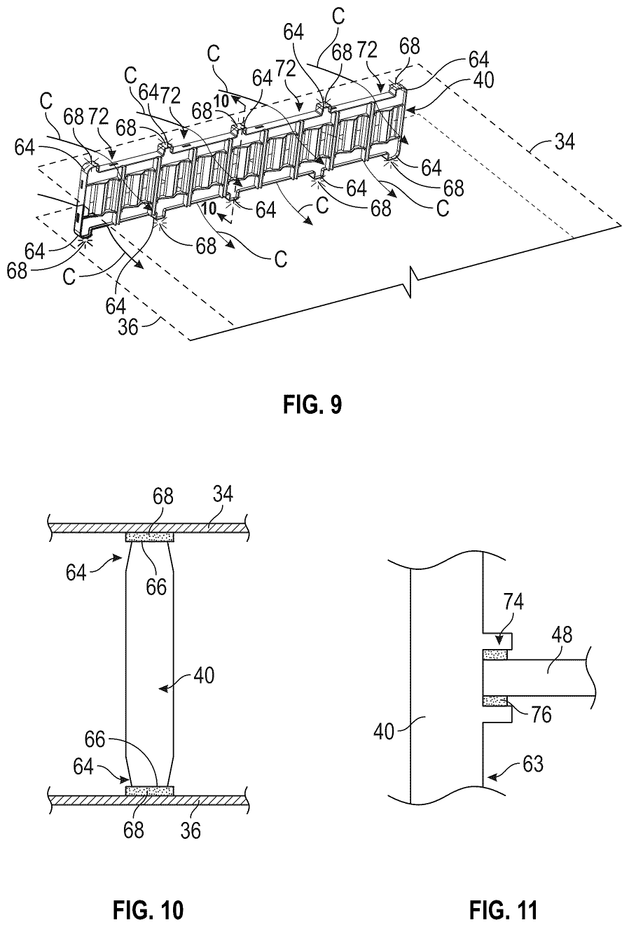

Referring now primarily to FIGS. 9-10, an adhesive 68 may be applied to the flat surface 66 of each leg 64 for securing the busbar frame 40 directly to the top cover 34 and/or bottom cover 36 of the array housing 32. The adhesive 68 may be an epoxy, a thermal interface material, a compressible material, etc. Notably, the adhesive 68 is not a mechanical fastener such as a screw, bolt, or rivet, for example. The legs 64 can therefore facilitate a mechanical fastenerless connection of the busbar frame 40 to the array housing 32. Advantageously, such a fastenerless connection does not require drilling through any portion of the array housing 32, which can prevent leakage of the coolant C. The proposed designs also save packaging space by eliminating the use of either external or internal mechanical fasteners for establishing a connection between the busbar frames 40 and the array housing 32.

In an assembled condition of the battery array 22, each gap 70 of the busbar frame 40 may establish a coolant flow passage 72 (see FIG. 9) for communicating the coolant C circulated by the thermal management system between the array housing 32 and the cell stack 30. The coolant flow passages 72 provide space between the cell stack 30 and the array housing 32 for the coolant C to flow over top of and/or below the battery cells 24 for immersion cooling the cell stack 30.

Referring now primarily to FIGS. 5, 6, and 11, one or more holders 74 may be provided on the first side face 63 of the busbar frame 40. Each holder 74 may provide an interface for engaging the cell spacers 48 to the busbar frame 40. In an embodiment, each holder 74 is U-shaped. However, other configurations are contemplated within the scope of this disclosure.

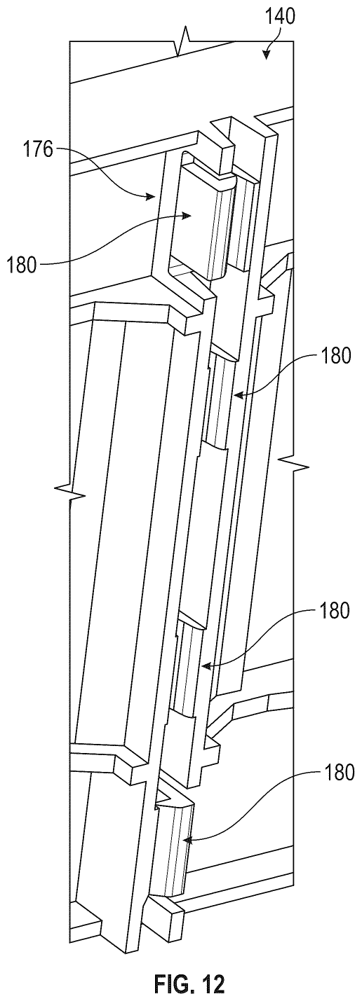

An adhesive 76 (see FIG. 11) may be utilized to secure the cell spacers 48 within the holders 74. The adhesive 76 may be an epoxy based adhesive or a urethane based adhesive, for example. Once adhesively secured within the holders 74, the cell spacers 48 and/or the busbar frame 140 are substantially constrained from movement, thereby increasing the structural integrity of the battery array 22. The adhesive 76 may further function to seal any gas paths between the busbar frame 40 and the cell spacers 48, thus preventing thermal energy from moving between adjacent battery cell groupings of the cell stack 30.

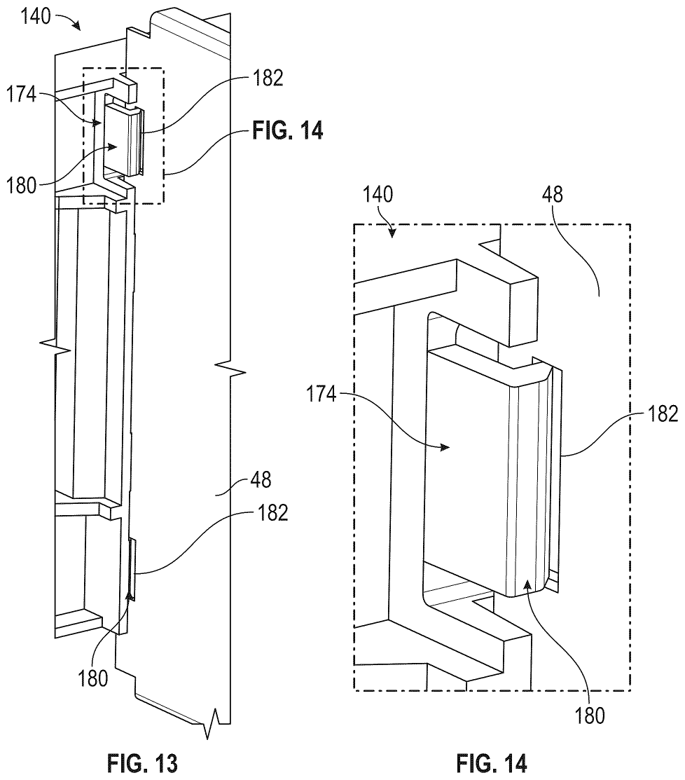

FIGS. 12-14 illustrate another exemplary busbar frame 140 that could be utilized within the battery array 22 described above. The busbar frame 140 is similar to the busbar frame 40 described above. However, in this exemplary embodiment, the busbar frame 140 includes modified holders 174 for engaging the cell spacers 48.

For example, each holder 174 may include one or more pairs of flexible hook structures 180. The flexible hook structures 180 may be configured to move relative to busbar frame 140 as the cell spacer 48 is inserted into the holder 174. The flexible hook structures 180 may flex outwardly away from the cell spacer 48 and then inwardly back toward the cell spacer 48 as the cell spacer is moved further into the holder 174. The flexible hook structures 180 may engage slots 182 formed in the cell spacer 48 in order to retain the cell spacer 48 relative to the busbar frame 140.

The exemplary battery arrays of this disclosure include busbar frames with novel features for facilitating battery array internal connections and thermal management. The busbar frames incorporate feet that facilitate a mechanical fastenerless design and that establish coolant flow passages for circulating coolant through the array for thermal management. The busbar frames further provide cell spacer holders for providing a structurally integrated array design.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
an array housing; and
a cell stack housed within the array housing and including a plurality of battery cells arranged between a first busbar frame and a second busbar frame,
wherein each of the first busbar frame and the second busbar frame includes a first leg configured to interface with the array housing.

2. The battery array as recited in claim 1, wherein the first leg interfaces with a top cover of the array housing.

3. The battery array as recited in claim 2, comprising an adhesive disposed between a flat surface of the first leg and the top cover.

4. The battery array as recited in claim 1, wherein the first leg interfaces with a bottom cover of the array housing.

5. The battery array as recited in claim 4, comprising an adhesive disposed between a flat surface of the first leg and the bottom cover.

6. The battery array as recited in claim 1, wherein the first leg interfaces with a top cover of the array housing, and a second leg of each of the first busbar frame and the second busbar frame interfaces with a bottom cover of the array housing.

7. The battery array as recited in claim 6, comprising a first adhesive disposed between a first flat surface of the first leg and the top cover, and a second adhesive disposed between a second flat surface of the second leg and the bottom cover.

8. The battery array as recited in claim 1, wherein each of the first busbar frame and the second busbar frame includes a second leg configured to interface with the array housing, and further wherein a gap extends between the first leg and the second leg.

9. The battery array as recited in claim 8, wherein the gap establishes a coolant flow passage inside the array housing.

10. The battery array as recited in claim 1, wherein each of the first busbar frame and the second busbar frame includes a holder configured to interface with a cell spacer of the cell stack.

11. The battery array as recited in claim 10, wherein the holder is U-shaped, and further comprising an adhesive disposed between the holder and the cell spacer.

12. The battery array as recited in claim 10, wherein the holder includes a pair of flexible hook structures that are configured to engage a slot formed in the cell spacer.

13. A battery array for a traction battery pack, comprising:
an array housing; and
a cell stack housed within the array housing and including a plurality of battery cells and a plurality of cell spacers arranged to extend laterally between a first busbar frame and a second busbar frame,
wherein each of the first busbar frame and the second busbar frame includes a first leg configured to interface with the array housing and a first holder configured to interface with a first cell spacer of the plurality of cell spacers.

14. The battery array as recited in claim 13, wherein the first holder is U-shaped, and further comprising an adhesive disposed between the first holder and the first cell spacer.

15. The battery array as recited in claim 13, wherein the first holder includes a pair of flexible hook structures that are configured to engage a slot formed in the first cell spacer.

16. The battery array as recited in claim 13, wherein the first leg interfaces with a top cover of the array housing, and comprising an adhesive disposed between a flat surface of the first leg and the top cover.

17. The battery array as recited in claim 13, wherein the first leg interfaces with a bottom cover of the array housing, and comprising an adhesive disposed between a flat surface of the first leg and the bottom cover.

18. The battery array as recited in claim 13, wherein the first leg interfaces with a top cover of the array housing, and a second leg of each of the first busbar frame and the second busbar frame interfaces with a bottom cover of the array housing.

19. The battery array as recited in claim 13, wherein each of the first busbar frame and the second busbar frame includes a second leg configured to interface with the array housing, and further wherein a gap extends between the first leg and the second leg.

20. The battery array as recited in claim 19, wherein the gap establishes a coolant flow passage inside the array housing.
